(19) United States
(12) Patent Application Publication
(10) Pub. No.: US 2018/0352285 A1
(43) Pub. Date: Dec. 6, 2018

(54) METHOD FOR PROVIDING A REMOTE PERSONAL COMPUTER SERVICE TO A DIGITAL DEVICE

(71) Applicant: NHN Entertainment Corporation, Seongnam-si (KR)

(72) Inventors: Young Jo CHOI, Seongnam-si (KR); Yunsu LEE, Seongnam-si (KR); CheolHyeon JO, Seongnam-si (KR)

(21) Appl. No.: 16/000,489

(22) Filed: Jun. 5, 2018

(30) Foreign Application Priority Data
Jun. 5, 2017 (KR) 10-2017-0069545

(51) Int. Cl. H04N 21/422; G06F 3/0482; G06F 9/50; G06F 21/30; G06F 21/31; G06F 3/14

(52) U.S. Cl. CPC H04N 21/42204; G06F 3/0482; G06F 3/1454; G06F 21/305; G06F 21/31; G06F 9/5005

(57) ABSTRACT

A method of connecting a digital device to a remote personal computer (PC) includes: requesting an access to the remote PC in response to executing a remote PC service through a user interface for changing a setting of the digital device; setting a network connection for providing the remote PC service in response to identifying request information associated with the request from the remote PC; encoding, by the remote PC, screen information displayed on the remote PC as a moving picture; receiving, by the digital device, the encoded moving picture from the remote PC; and decoding, by the digital device the encoded moving picture and playing the screen information of the remote PC on a display of the digital device.

### CROSS-REFERENCE TO RELATED APPLICATION

This application claims priority from and the benefit of Korean Patent Application No. 10-2017-0069545, filed on Jun. 5, 2017, which is hereby incorporated by reference for all purposes as if fully set forth herein.

### BACKGROUND

### Field

Exemplary embodiments/implementations of the invention relate generally to a technique for connecting a digital device to a remote personal computer (PC) and using a PC function in the digital device.

### Discussion of the Background

In general, a television (TV) has a function of receiving a broadcasting image and displaying the received image. Since the device specification of a conventional TV is low, a general function of the conventional TV relates to outputting, that is, displaying an image. A PC service may be available through connection to a separate external device to use a PC function on such the conventional TV.

With a high-end chipset being installed on a TV, smart TVs that support various services are provided, as disclosed in Korean Patent Application Publication No. 10-2012-0047487. A smart TV may provide various functions, such as web surfing, video-on-demand (VOD) watching, a social network service, and a game, by installing various applications (apps) through combination of an Internet access function with the TV. Here, the PC service may be used by downloading and installing a PC service application through a store provided from the smart TV to use the PC function on the smart TV. However, since a platform of a smart TV is different for each manufacturer, an application installable in each supported smart TV may be limited. Although the application is provided through the store, there may be some constraints in installing the application based on an environment of a device.

Accordingly, there is a need for a technology that enables a PC function to be available even on a generic TV, which is not a smart TV, without a separate physical device to provide a PC function.

The above information disclosed in this Background section is only for understanding of the background of the inventive concepts, and, therefore, it may contain information that does not constitute prior art.

### SUMMARY

Devices constructed and methods according to exemplary embodiments of the invention may provide a remote personal computer (PC) technology. More particularly, at least one exemplary embodiment may provide a method and apparatus of providing a remote PC service by connecting a digital device to a remote PC.

Additional features of the inventive concepts will be set forth in the description which follows, and in part will be apparent from the description, or may be learned by practice of the inventive concepts.

According to one or more embodiments of the invention, a method of connecting a digital device to a remote personal computer (PC) includes: requesting an access to the remote PC in response to executing a remote PC service through a user interface for changing a setting of the digital device; setting a network connection for providing the remote PC service in response to identifying request information associated with the request from the remote PC; encoding, by the remote PC, screen information displayed on the remote PC as an encoded moving picture; receiving, by the digital device, the encoded moving picture from the remote PC; and decoding, by the digital device the encoded moving picture and playing the screen information of the remote PC on a display of the digital device.

The method may further include: providing an access scheme for connecting to the remote PC, the access scheme including a menu screen-based PC service execution scheme for providing the user interface of changing the setting of the digital device or an application-based PC service execution scheme for executing the remote PC service.

The requesting of the access to the remote PC may include: storing remote PC information that includes an Internet protocol (IP) address or domain information of the remote PC used to connect to the remote PC, and inputting the IP address or the domain information of the remote PC to which the digital device desires to connect, based on the stored remote PC information.

The requesting of the access to the remote PC may include performing a log-in process based on an identifier (ID) and a password in response to executing the remote PC service, and requesting the access to the remote PC based on identification information of a user for the log-in process.

The method may further include: identifying information of an input/output (I/O) device in response to detecting a connection of the I/O device, and transmitting an input value of the connected I/O device to the remote PC in response to receiving an input of an instruction for the connected I/O device from a user.

The transmitting of the input value may include encoding screen information associated with a function of the remote PC executed on the remote PC as an encoded moving picture in response to executing the function of the remote PC on the remote PC based on the input value of the connected I/O device, and streaming the encoded moving picture.

The requesting of the access to the remote PC may include executing the remote PC service by constructing an operating system (OS) environment.

The requesting of the access to the remote PC may include selecting at least one of a plurality of PC resources provided from the remote PC.

The requesting of the access to the remote PC may include managing resource information associated with the plurality of PC resources provided from the remote PC.

According to one or more embodiments of the invention, a digital device for connecting to a remote personal computer (PC), includes: a provider configured to provide an access scheme for connecting to the remote PC; a requester configured to request an access to the remote PC in response to executing a remote PC service through a user interface for changing a setting of the digital device; a setter configured to set a network connection for providing the remote PC service in response to identifying of request information associated with the request being completed in the remote PC; a receiver configured to encode screen information being displayed on the remote PC as an encoded moving picture, to receive an encoded moving picture from the remote PC, the encoded moving picture being generated by the remote PC by encoding a screen information displayed on the remote PC as a moving picture; and a player configured to decode the encoded moving picture received from the remote PC and to play the screen information of the remote PC on a display of the digital device.

The provider may be configured to provide the access scheme for connecting to the remote PC, the access scheme including a menu-screen based PC service execution scheme for providing the user interface of changing the setting of the digital device or an application-based PC service execution scheme for executing the remote PC service.

The digital device may further include: a storage configured to store remote PC information that includes an Internet protocol (IP) address or domain information of the remote PC used to connect to the remote PC, wherein the requester may be configured to input the IP address or the domain information of the remote PC to which the digital device desires to connect, based on the stored remote PC information.

The requester may be configured to perform a log-in process based on an identifier (ID) and a password in response to executing the remote PC service, and to request the access to the remote PC based on identification information of a user that performs the log-in process.

The digital device may further include: a transmitter configured to identify information of an input/output (I/O) device in response to detecting a connection of the I/O device, and to transmit an input value of the connected I/O device to the remote PC in response to receiving an input of an instruction for the connected I/O device from a user.

The transmitter may be configured to encode screen information associated with a function of the remote PC executed on the remote PC as an encoded moving picture in response to executing the function of the remote PC on the remote PC based on the input value of the connected I/O device, and to stream the encoded moving picture.

The requester may be configured to execute the PC remote service by constructing an operating system (OS) environment.

The requester may be configured to select at least one of a plurality of PC resources provided from the remote PC, and to manage resource information associated with the plurality of PC resources provided from the remote PC.

According to one or more embodiments of the invention, a method of connecting to a remote personal computer (PC) using an application executed on a digital device, includes: storing remote PC information that includes an Internet protocol (IP) address or domain information of the remote PC; redirecting the remote PC information to the digital device in response to executing a remote PC service for connecting to the remote PC; transmitting an access request from the digital device to the remote PC based on the remote PC information; receiving a connection accept signal from the remote PC, the connection accept signal transmitted from the remote PC in response to the access request; requesting the remote PC for screen information displayed on the remote PC; receiving a moving picture that is generated in response to encoding the screen information being displayed on the remote PC, and requesting the digital device for decoding the encoded moving picture; and playing the screen information being displayed on the remote PC in response to decoding the encoded moving picture at the digital device, and receiving a result about the screen information of the remote PC being played.

The method may further include: receiving an input value of an input/output (I/O) device in response to receiving an input of an instruction for the I/O device connected to the digital device; redirecting the input value of the I/O device to the remote PC; decoding, by the digital device, the moving picture that is generated in response to encoding the screen information executed on the remote PC based on the input value, and receiving the result about the screen information of the remote PC being played at the digital device; and terminating the connection to the remote PC by receiving a use end request of the remote PC service from the user and by transmitting the use end request to the remote PC.

According to one or more embodiments of the invention, a method of operating a remote personal computer (PC) service in a remote PC, includes: receiving an access request from a digital device; identifying request information associated with the access request of the digital device and setting a network connection with the digital device; encoding screen information being displayed on the remote PC service as an encoded moving picture; and streaming the encoded moving picture to the digital device, wherein the streaming of the encoded moving picture may include decoding the encoded moving picture, by the digital device, in response to receiving the encoded moving picture from the remote PC, and playing the decoded moving picture on a display of the digital device.

According to some exemplary embodiments, a digital device may use the same PC function as if a PC is in a home by connecting to the remote PC and by playing screen information being displayed on the remote PC.

Also, according to some exemplary embodiments, a digital device may further conveniently use a PC function through an I/O device connected to the digital device.

Also, according to exemplary embodiments, a digital device may use a PC service without restrictions on a time and an occasion by installing an application capable of using the PC service and by connecting to a remote PC without a separate device. The digital device may selectively use the PC service provided from the remote PC.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 illustrates an example of a network environment according to an exemplary embodiment.

FIG. 2 is a block diagram illustrating a configuration of a digital device according to an exemplary embodiment.

FIG. 3 is a flowchart illustrating an example of a method of selecting a scheme for connecting a digital device to a remote personal computer (PC) according to an exemplary embodiment.

FIG. 4 is a flowchart illustrating an example of a method of connecting a digital device to a remote PC according to an exemplary embodiment.

FIGS. 5A and 5B illustrate a flowchart of another example of a method of connecting a digital device to a remote PC according to an exemplary embodiment.

FIG. 6 illustrates an example of executing a PC service on a digital device according to an exemplary embodiment.

FIG. 7 illustrates an example of redirecting an I/O device connected to a digital device to a remote PC according to an exemplary embodiment.

FIG. 8 illustrates an example of providing a PC service on a digital device according to an exemplary embodiment.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

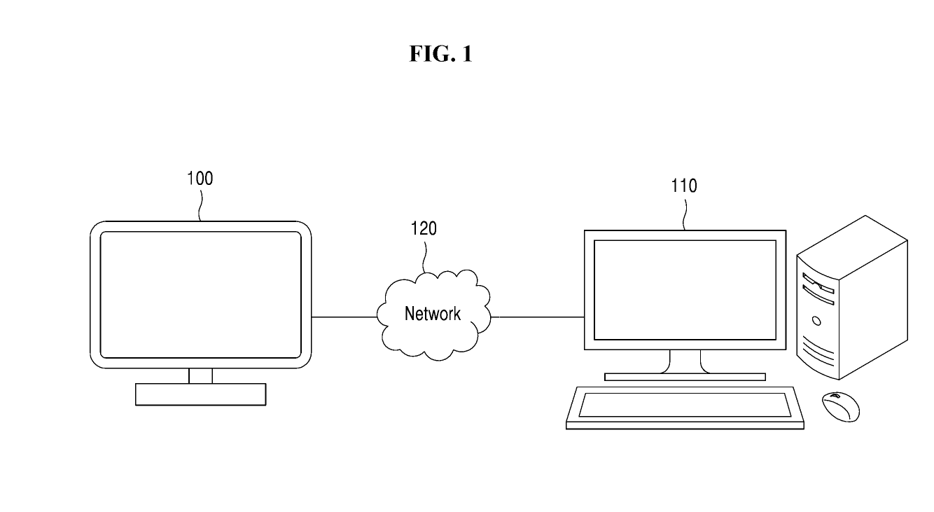

FIG. 1 is a diagram illustrating an example of a network environment according to an exemplary embodiment. A digital device 100 may be a fixed terminal or a mobile terminal that is configured as, for example, a computer device. Examples of the digital device 100 may include a smartphone, a mobile phone, a navigation, a computer, a laptop computer, a digital broadcasting terminal, a personal digital assistant (PDA), a portable multimedia player (PMP), a tablet personal computer (PC), a smart television (TV), a TV, and the like. Also, the digital device 100 may include a set-top box that is equipment for receiving digital broadcast. For example, the digital device 100 may communicate with other user terminals and/or a server over a network 120 in a wireless communication manner or a wired communication manner.

The digital device 100 may be a digital equipment in which an operating system (OS) is constructed and configured to output an image although the OS is not supported. In detail, the digital device 100 may be a TV that may only allow a single direction broadcasting and may be a smart TV that enables an Internet-based interactive service in addition to such single direction broadcasting. The smart TV refers to a multifunctional TV capable of using various functions, such as web surfing, video-on-demand (VOD) watching, a social network service, and a game, by installing various applications (apps) through combination of an Internet access function with the TV.

The communication scheme is not particularly limited and may include a communication method that uses a near field communication between devices as well as a communication method using a communication network, for example, a mobile communication network, the wired Internet, the wireless Internet, and a broadcasting network, which may be included in the network 120. For example, the network 120 may include at least one of networks topologies that include networks, for example, a personal area network (PAN), a local area network (LAN), a campus area network (CAN), a metropolitan area network (MAN), a wide area network (WAN), a broadband network (BBN), the Internet, and the like. Also, the network 120 may include at least one of network topologies that include a bus network, a star network, a ring network, a mesh network, a star-bus network, a tree or hierarchical network, and the like. However, it is only an example and the exemplary embodiments are not limited thereto.

A remote PC 110 refers to a device for providing a PC service to the digital device 100 at a remote location. The digital device 100 and the remote PC 110 may be present in different networks, respectively. The remote PC 110 may provide a plurality of PC resources. For example, the remote PC 110 may provide various PC resources including an OS environment, such as Windows (2000, 7, 8, 8.1, or 10), MacOS, Linux, etc., and may provide a PC resource selected by the digital device 100 to the digital device 100. The digital device 100 may use the selected PC resource.

For example, the digital device 100 may be installed in a home, and may connect to the remote PC 110 not present in the same network as that of the digital device 100 and, through this connection, may be available in the same manner as an at-home installed PC.

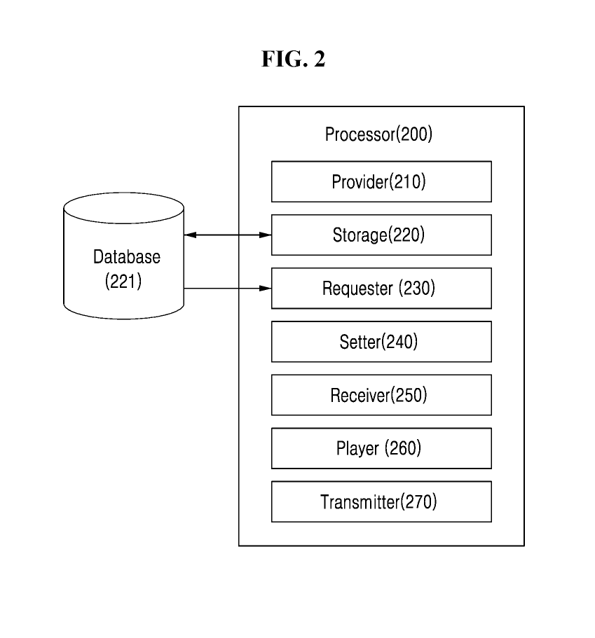

FIG. 2 is a block diagram illustrating a configuration of a digital device according to an exemplary embodiment.

Referring to FIG. 2, the digital device 100 illustrated in FIG. 1 may include a processor 200, which may include a provider 210, a storage 220, a requester 230, a setter 240, a receiver 250, a player 260, and a transmitter 270. The processor 200 may load, to a memory, a program code stored in a program file for a method of connecting to the remote PC. The processor 200 and the components of the processor 200 may be configured to execute instructions according to a code of at least one program and a code of an OS included in the memory. Here, the components of the processor 200 may be representations of different functions that are performed by the processor 200 in response to a control instruction provided from the program code stored in the digital device 100.

The provider 210 may provide an access scheme for connecting to the remote PC. Here, the access scheme for connecting to the remote PC may include a menu-screen based PC service execution scheme for providing a user interface of changing a setting of the digital device 100 or an application-based PC service execution scheme for executing a PC service.

The storage 220 may store, in a database 221, remote PC information that includes an Internet protocol (IP) address or domain information of the remote PC used to connect to the remote PC. Also, the storage 220 may store information of an I/O device connected to the digital device 100.

The requester 230 may request access to the remote PC by executing the PC service through the user interface of changing the setting of the digital device 100. Alternatively, the requester 230 may request the access to the remote PC by executing a PC service through an application for executing the PC service. Here, the requester 230 may input an IP address or a domain address of the remote PC to which the digital device 100 desires to connect, based on the remote PC information stored in the storage 220, and may input the IP address or domain information of the remote PC redirected from a PC application. Also, the requester 230 may perform a log-in based on an identifier (ID) and a password in response to executing the PC service and may request the access to the remote PC based on identification information of a user that performs the log-in.

The requester 230 may execute the PC service by constructing the OS environment. The requester 230 may select at least one PC resource among the plurality of PC resources provided from the remote PC, and may manage resource information associated with the plurality of PC resources provided from the remote PC.

The setter 240 may approve a network connection for providing the PC service in response to identifying request information associated with the request from the remote PC and may set the network connection between the digital device 100 and the remote PC.

Screen information being displayed on the remote PC may be encoded as a moving picture by the remote PC and the receiver 250 may receive the encoded moving picture that is transmitted from the remote PC.

The player 260 may decode the encoded moving picture and may play the decoded moving picture on a display of the digital device 100.

In response to detecting a connection of an I/O device, the transmitter 270 may identify information of the connected I/O device. In response to receiving an instruction for the connected I/O device from the user, the transmitter 270 may transmit an input value of the connected I/O device to the remote PC. The transmitter 270 may encode screen information associated with a function of the remote PC executed on the remote PC as a moving picture, in response to executing the function of the remote PC on the remote PC based on the input value of the connected I/O device, and may stream the encoded moving picture.

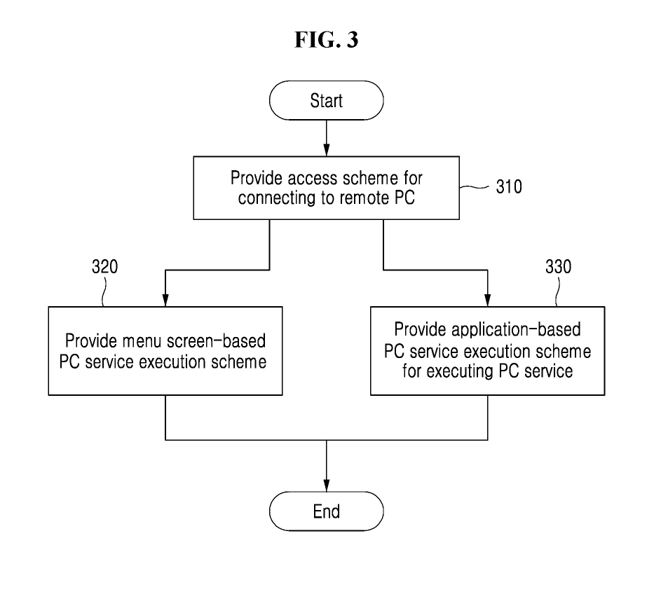

FIG. 3 is a flowchart illustrating an example of a method of selecting a scheme for connecting a digital device to a remote PC according to an exemplary embodiment.

Referring to FIG. 3, a plurality of schemes may be employed to connect the digital device to the remote PC. In operation 310, the digital device may provide an access scheme for connecting to the remote PC. For example, the digital device may provide the access scheme for connecting to the remote PC in a list form. Also, if the access scheme for connecting to the remote PC is updated, the digital device may apply, for example, add and delete, the updated access scheme to the list.

Here, at least one access scheme may be selected by a user among access schemes provided from the digital device, and a process of connecting to the remote PC may be performed based on the selected access scheme. Alternatively, a process of connecting to the remote PC may be performed based on an access scheme provided from the digital device.

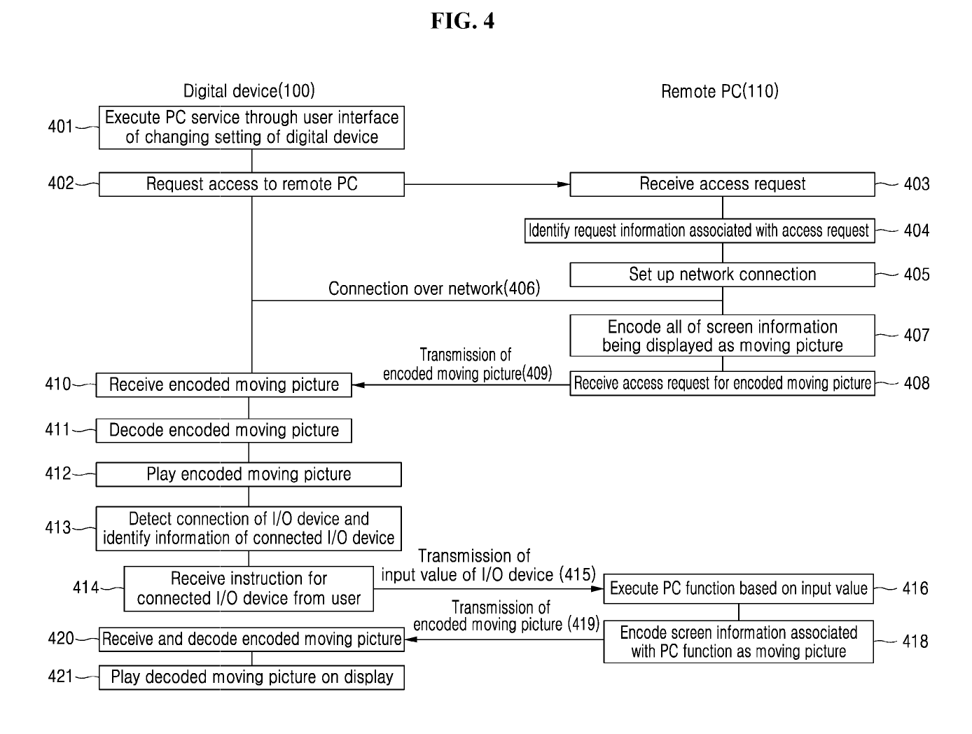

In operation 320, the digital device may provide a menu screen-based PC service execution scheme. The digital device may provide a user interface for changing a setting of the digital device and a PC service may be executed by the user through the user interface. For example, if the digital device is a generic TV that provides only a screen output function, the menu screen-based PC service execution scheme may be performed. The menu screen-based PC service execution scheme may be further described with reference to FIG. 4.

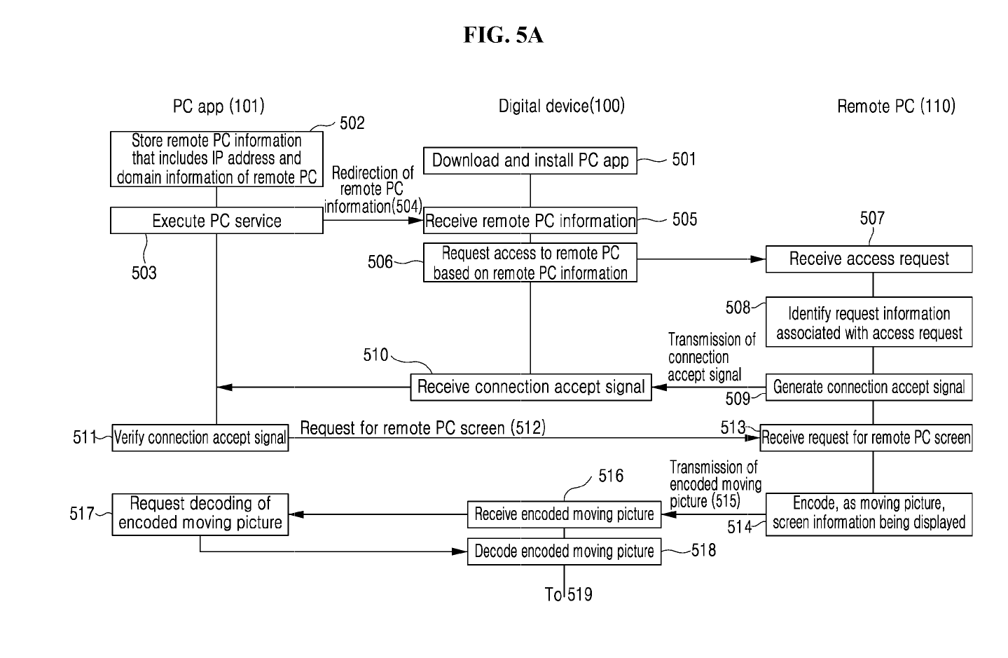

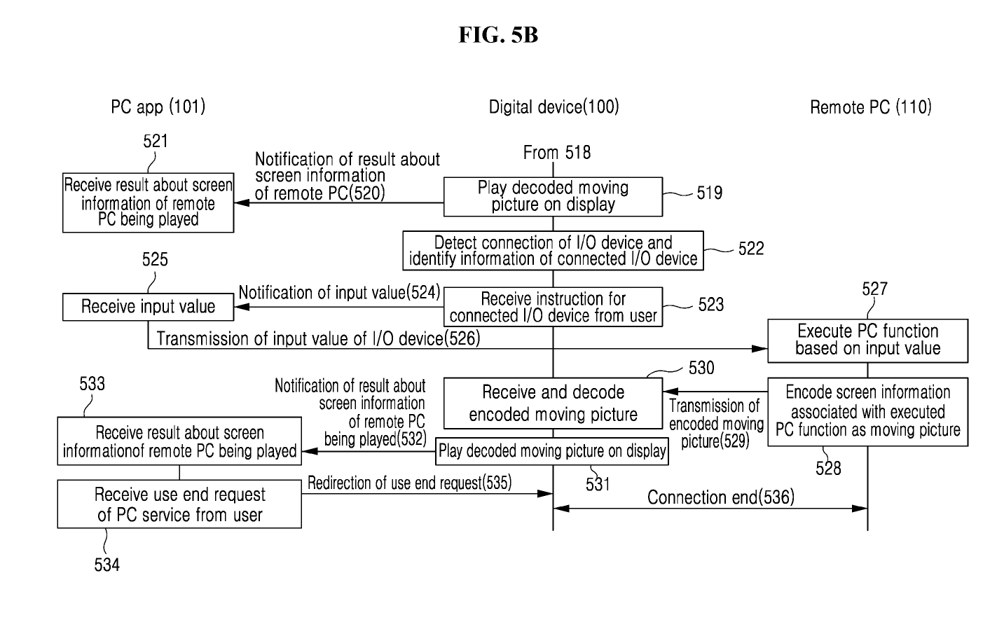

In operation 330, the digital device may provide an application-based PC service scheme for executing the PC service. For example, if the digital device includes an OS and is capable of downloading and installing an application, the PC service execution scheme may be performed by installing the application on the digital device. The PC service execution scheme may be further described with reference to FIG. 5.

FIG. 4 is a flowchart illustrating an example of a method of connecting to a remote PC in a digital device according to an exemplary embodiment.

Referring to FIG.4, the digital device 100 may be connected to the remote PC 110 through a menu screen provided on the digital device 100 is described. The digital device 100 may provide a user interface of changing a setting of the digital device 100. Here, the user interface of changing the setting of the digital device 100 may be a menu screen that is basically provided from the digital device 100 and may provide a function for connection to an external device on the menu screen.

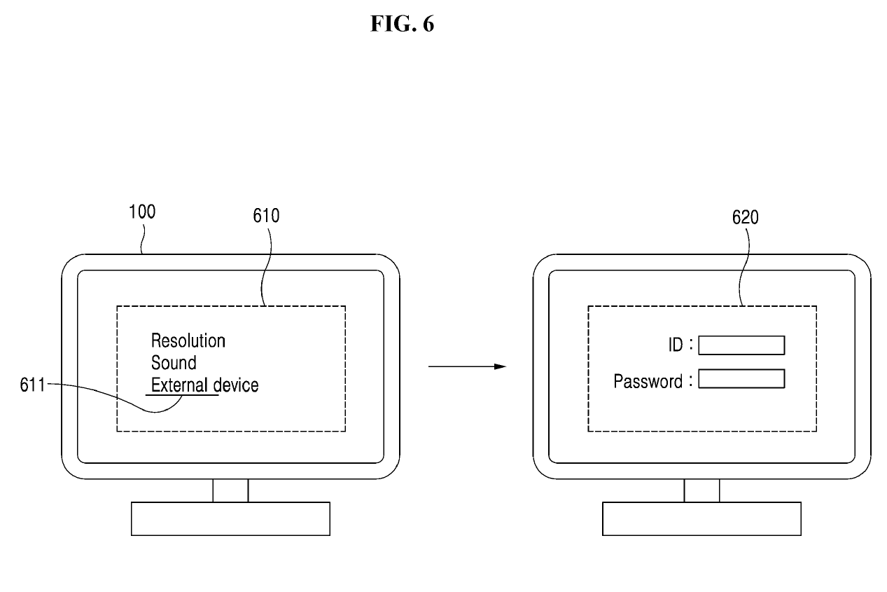

Referring to FIG. 4, in operation 401, the digital device 100 may execute a PC service through the user interface for changing the setting of the digital device 100. A method of executing the PC service on the digital device 100 will be described with reference to FIG. 6.

FIG. 6 illustrates an example of executing a PC service on a digital device according to an exemplary embodiment. Referring to FIG. 6, a user may connect to a menu screen 610 provided from the digital device 100 through a remote controller and a PC service for connecting to the remote PC 110 may be executed on the menu screen 610. In detail, the menu screen 610 of the digital device 100 may provide a function capable of changing, for example, a resolution and a sound, as a basic screen for changing an environment set in the digital device 100. Also, the digital device 100 may provide a function capable of connecting to an external device. The user may select an external device function 611 for connecting to the external device. Here, the remote controller may be a device, for example, a smartphone, capable of controlling the digital device 100 in interaction with the digital device 100.

An access to the remote PC 110 may be requested by executing the PC service on the digital device 100. For example, once the digital device 100 executes the PC service, a log-in box 620 for inputting an ID and a password for connection to the remote PC 110 may be displayed on the digital device 100. The user may log in the PC service by inputting, that is, entering the ID and the password for connecting to the remote PC 110. If the ID and the password input from the user match, the remote PC 110 may be connected to the digital device 100.

Here, the digital device 100 may request the access to the desired remote PC 110 by inputting an IP address or domain information of the remote PC 110 in advance. The digital device 100 may pre-store the IP address or domain information of the remote PC 110 before using the PC service. The digital device 100 may connect to the remote PC 110 based on the stored remote PC information and may provide the user with remote PC information regarding the remote PC 110 to which the user connects.

In operation 402, the digital device 100 may request the access to the remote PC 110. In operation 403, the remote PC 110 may receive the access request. In operation 404, the remote PC 110 may identify request information associated with the access request. The remote PC 110 may receive the access request from the digital device 100 and may verify whether the access is a normal access. Once the access request from the digital device 100 is verified to be normal, the remote PC 110 may set up a network connection with the digital device 100 in operation 405. In operation 406, the remote PC 110 and the digital device 100 may be connected over a network.

In operation 407, the remote PC 110 may encode all of screen information being displayed as a moving picture. In operation 408, the remote PC 110 may receive an access request for the encoded moving picture, for example, the encoded screen information of the remote PC 110. In operation 409, the remote PC 110 may transmit the encoded moving picture to the digital device 100 connected over the network. The digital device 100 may receive the encoded moving picture in operation 410 and may decode the encoded moving picture in operation 411. In operation 412, the digital device 100 may play the screen information of the remote PC 110 decoded by decoding the encoded moving picture on a display of the digital device 100.

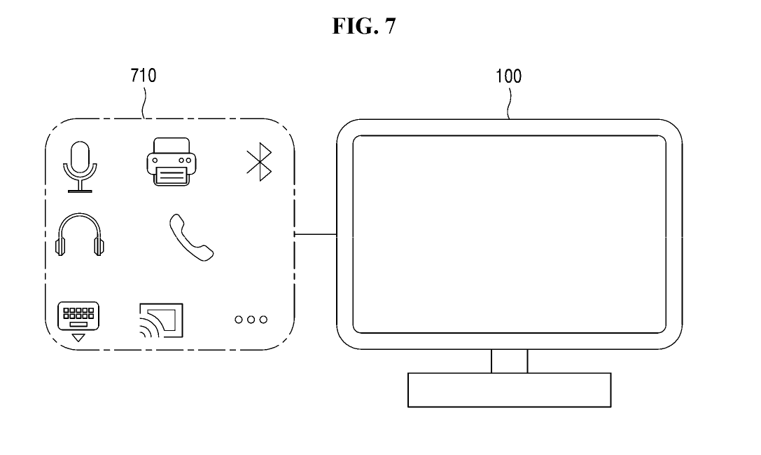

In operation 413, the digital device 100 may detect a connection of an I/O device and may identify information of the connected I/O device. A method of redirecting the I/O device connected to the digital device 100 to the remote PC 110 will be described with reference to FIG. 7.

FIG. 7 illustrates an example of redirecting an I/O device connected to a digital device to a remote PC according to an exemplary embodiment. Referring to FIG. 7, a universal serial bus (USB) terminal, a high definition multimedia interface (HDMI) port, etc., for is connection to an external device may be provided from the digital device 100. An I/O device 710 may be connected to the digital device 100 through the USB terminal provided from the digital device 100. The digital device 100 may use a PC function provided from the remote PC 110 using the I/O device 710 connected to the digital device 100. The I/O device 710 refers to a device that enables exchange information between a computer and a user as a component of a digital computer. An input device is used to input data into the computer, and reads data, such as a character, a diagram, a voice, and a number, from the user, converts the read data to a binary form of 0 and 1, so that the converted data may be computer-processible. For example, the input device may include a mouse, a keyboard, a joystick, a microphone, a digitizing pad, a webcam, a barcode reader, a digital camera, an optical scanner, and a digital camcorder. An output device is a device used to convert the computer-processed data to a user-recognizable form and to display the converted data, and may include, for example, a monitor, a projector, and a printer.

In operation 414, an instruction for the connected I/O device may be received from the user. For example, a keyboard and a mouse corresponding to input devices of a PC may be connected to the digital device 100 and the user may control the keyboard and the mouse connected to the digital device 100. Here, an input value may be generated in response to controlling the keyboard and the mouse. In operation 415, the digital device 100 may redirect the input value of the connected I/O device to the remote PC 110. In operation 416, the remote PC 110 may execute a PC function based on the input value of the I/O device redirected from the digital device 100.

In operation 418, the remote PC 110 may encode screen information associated with the executed PC function as a moving picture. In operation 419, the encoded moving picture may be streamed to the digital device 100. In operation 420, the digital device 100 may receive the encoded moving picture and decode the encoded moving picture. In operation 421, the digital device 100 may play the decoded moving picture on the display. Accordingly, the PC function may be available at the digital device 100 and a result of using the PC function may be provided to the user.

According to exemplary embodiments, since a digital device may connect to a remote PC through a PC service providing function of the digital device, even a device on which an application is incapable of being installed may use a PC service.

FIGS. 5A and 5B illustrate a flowchart of another example of a method of connecting to a remote PC in a digital device according to an exemplary embodiment.

A method of connecting to the remote PC 110 through an application for executing a PC service on the digital device 100 will be described. Here, the application is also referred to as a PC app 101. Hereinafter, For convenience of explanation, FIG. 5A and FIG. 5B will be described separately.

Referring to FIG. 5A, in operation 501, the digital device 100 may download the PC app 101 and the downloaded PC app 101 may be installed on the digital device 100. For example, if the digital device 100 is a smart TV, the digital device 100 may download the PC app 101 through connection to a store. In operation 502, the PC app 101 may store remote PC information that includes an IP address and domain information of the remote PC 110. To use a PC function in the digital device 100, the PC app 101 installed on the digital device 100 may be executed. In operation 503, the PC app 101 may execute the PC service. In operation 504, the PC app 101 may verify the stored remote PC information and may redirect the remote PC information to the digital device 100.

In operation 505, the digital device 100 may receive the remote PC information from the PC app 101. In operation 506, the digital device 100 may request an access to the remote PC 110 based on the remote PC information. That is, the digital device 100 may attempt to connect to the remote PC 110. In operation 507, the remote PC 110 may receive the access request. In operation 508, in response to the received access request, the remote PC 110 may identify request information associated with the access request. The remote PC 110 may verify whether the access request received from the digital device 100 is a normal access. Once the access request is verified to be normal, the remote PC 110 may generate a connection accept signal in operation 509. In operation 510, the remote PC 110 may transmit the connection accept signal to the digital device 100 and the digital device 100 may receive the connection accept signal. Here, the PC app 101 running on the digital device 100 may verify the connection accept signal received from the remote PC 110 in operation 511 and may request the remote PC 110 for a remote PC screen in operation 512. In operation 513, the remote PC 110 may receive the request for the remote PC screen from the PC app 101.

In operation 514, the remote PC 110 may encode, as a moving picture, all of screen information being displayed on the remote PC 110. In operation 515, the remote PC 110 may transmit the encoded moving picture to the digital device 100. In operation 516, the digital device 100 may receive the encoded moving picture from the remote PC 110. In operation 517, the PC app 101 may request the digital device 100 to decode the encoded moving picture. In operation 518, the digital device 100 may decode the encoded moving picture.

Referring to FIG. 5B, in operation 519, the digital device 100 may play, on the display of the digital device 100, the remote PC screen that is decoded by decoding the encoded moving picture. In operation 520, the digital device 100 may notify the PC app 101 of a result about screen information (screen information of the remote PC 110) that is being displayed on the digital device 100. In operation 521, the PC app 101 may receive the result about the screen information of the remote PC 110 being played on the digital device 100.

In operation 522, the digital device 100 may detect a connection of an I/O device and may identify information of the connected I/O device. A method of redirecting the I/O device connected to the digital device 100 to the remote PC 110 will be described with reference to FIG. 7. Referring to FIG. 7, a USB terminal, an HDMI port, etc., for connection to an external device may be provided from the digital device 100. The I/O device 710 may be connected to the digital device 100 through the USB terminal provided from the digital device 100. The digital device may use a PC function provided from the remote PC 110 using the I/O device 710 connected to the digital device 100. The method of redirecting the I/O device connected to the digital device to the remote PC according to the exemplary embodiment may be substantially identical to the method described with reference to the operation 413 in FIG. 4, and therefore, it may be omitted.

In operation 523, an instruction for the connected I/O device may be received from the user. For example, a keyboard and a mouse corresponding to input devices of a PC may be connected to the digital device 100 and the user may control the keyboard and the mouse connected to the digital device 100. Here, an input value may be generated in response to controlling the keyboard and the mouse. In operation 524, the digital device 100 may notify the PC app 101 of the input value of the connected I/O device. In operation 525, the PC app 101 may receive the input value of the I/O device. In operation 526, the PC app 101 may transmit the input value of the I/O device to the remote PC 110. In operation 527, the remote PC 110 may execute a PC function based on the input value.

In operation 528, the remote PC 110 may encode screen information associated with the executed PC function as a moving picture. In operation 529, the encoded moving picture may be streamed to the digital device 100. In operation 530, the digital device 100 may receive the encoded moving picture and decode the encoded moving picture. In operation 531, the digital device 100 may play the decoded moving picture on the display. In operation 532, the digital device 100 may notify the PC app 101 of a result about screen information of the remote PC 110 being played on the display of the digital device 100. In operation 533, the PC app 101 may receive the result about screen information of the remote PC 110 being played.

In operation 534, the PC app 101 may receive a use end request of the PC service from the user. In operation 535, the PC app 101 may redirect the use end request to the digital device 100. In response thereto, the connection between the digital device 100 and the remote PC 110 may be terminated in operation 536.

According to exemplary embodiments, a digital device may connect to a remote PC by installing an application for executing a PC service on the digital device, and the digital device may use a PC function provided from the remote PC, if necessary, at any time. Also, a desired PC resource may be used among various PC services, for example, Window XP, Window 7, and MAC, provided from the remote PC based on the digital device.

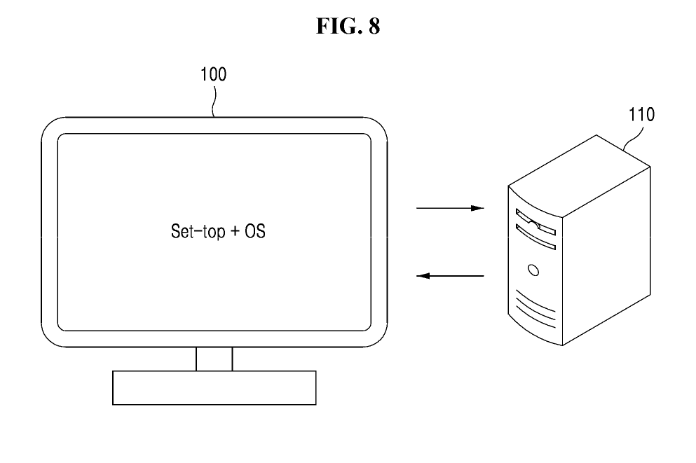

FIG. 8 illustrates an example of providing a PC service on a digital device according to an exemplary embodiment.

A method of providing a Desktop as a Service (DaaS) through the digital device 100 will be described with reference to FIG. 8. A remote PC service may be provided by installing an app capable of using a PC service on the digital device 100. For example, an SDK capable of using a remote PC service may be provided to an existing set-top development company. A manufacturing company including such a set-top development company may provide a remote service application through the SDK.

The digital device 100 may use a function of the remote PC 110 by installing the application capable of using the PC service. Here, the remote PC 110 may provide the PC service based on a cloud and may include remote PC hardware farm and remote PC storage. The remote PC 110 may store information for providing the PC service to the digital device 100 in the remote PC storage. The remote PC hardware farm refers to a group of the remote PCs 110 and may distributively deploy a plurality of digital devices 100 based on a preset criterion, for example, a region and a country. The remote PC hardware farm may be managed to be separate from a network of the digital device 100. The remote PC hardware farm may immediately replace the remote PC 110 with another remote PC 110 although the remote PC 110 is ceased.

A PC service application may be installed and executed on the digital device 100 through the SDK. In response to installing and executing the PC service application on the digital device 100, an image sound of the remote PC 110 may be provided using a streaming method. Accordingly, the digital device 100 may use the remote PC service that is provided from the remote PC 110. For example, the digital device 100 may be a set-top box. If the digital device 100 is a set-top box, the remote PC service may be provided to another digital device connected to the set-top box. Since an OS environment is supported in the set-top box, a PC resource provided from the remote PC 110 may be available at any time. Accordingly, a network cost may decrease gradually. Accordingly, in terms of cost, it may be further effective to use the remote PC service from the remote PC 110 through the digital device 100 rather than replacing hardware of the digital device 100.

Also, the digital device 100 may redirect an I/O device connected to the digital device 100 to the remote PC 110. The digital device 100 may perform a management, such as share, allocate, and control the I/O device for the remote PC 110. For example, the digital device 100 may redirect, to the remote PC 110, a control signal of the I/O device connected to the digital device 100, and, in response to the control, the remote PC 110 may provide the remote PC service including a function of the I/O device to the digital device 100. Also, the digital device 100 may manage resources associated with a resource pool of the remote PC 110.

According to a conventional DaaS service, a separate device for using a remote service of a desktop or a separate application executed on a general desktop, for example, WINDOWS and MAC is necessary. According to exemplary embodiments, the OS may be constructed on the digital device, and the digital device with a low processing power may utilize a high performance remote PC service. Also, issue of incompatibility between applications provided by various digital device manufacturers may be overcome.

The systems or apparatuses described herein may be implemented using hardware components, software components, and/or a combination thereof. For example, the apparatuses and the components described herein may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the above-described exemplary embodiments may be recorded in non-transitory computer-readable media including program instructions to implement various operations of the above-described exemplary embodiments. The media may also include, alone or in combination with the program instructions, data files, data structures, and the like. The program instructions recorded on the media may be those specially designed and constructed for the purposes of exemplary embodiments, or they may be of the kind well-known and available to those having skill in the computer software arts. Examples of non-transitory computer-readable media include magnetic media such as hard disks, floppy disks, and magnetic tapes; optical media such as CD-ROM discs, and DVDs; magneto-optical media such as floptical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The above-described devices may be configured to act as one or more software modules in order to perform the operations of the above-described exemplary embodiments, or vice versa.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A method of connecting a digital device to a remote personal computer (PC), the method comprising:
requesting an access to the remote PC in response to executing a remote PC service through a user interface for changing a setting of the digital device;
setting a network connection for providing the remote PC service in response to identifying request information associated with the request from the remote PC;
encoding, by the remote PC, screen information displayed on the remote PC as an encoded moving picture;
receiving, by the digital device, the encoded moving picture from the remote PC; and
decoding, by the digital device the encoded moving picture and playing the screen information of the remote PC on a display of the digital device.

2. The method of claim 1, further comprising:
providing an access scheme for connecting to the remote PC, the access scheme including a menu screen-based PC service execution scheme for providing the user interface of changing the setting of the digital device or an application-based PC service execution scheme for executing the remote PC service.

3. The method of claim 1, wherein the requesting of the access to the remote PC comprises:
storing remote PC information that includes an Internet protocol (IP) address or domain information of the remote PC used to connect to the remote PC, and inputting the IP address or the domain information of the remote PC to which the digital device desires to connect, based on the stored remote PC information.

4. The method of claim 1, wherein the requesting of the access to the remote PC comprises performing a log-in process based on an identifier (ID) and a password in response to executing the remote PC service, and requesting the access to the remote PC based on identification information of a user for the log-in process.

5. The method of claim 1, further comprising:
identifying information of an input/output (I/O) device in response to detecting a connection of the I/O device, and transmitting an input value of the connected I/O device to the remote PC in response to receiving an input of an instruction for the connected I/O device from a user.

6. The method of claim 5, wherein the transmitting of the input value comprises encoding screen information associated with a function of the remote PC executed on the remote PC as a moving picture in response to executing the function of the remote PC on the remote PC based on the input value of the connected I/O device, and streaming the encoded moving picture.

7. The method of claim 1, wherein the requesting of the access to the remote PC comprises executing the remote PC service by constructing an operating system (OS) environment.

8. The method of claim 1, wherein the requesting of the access to the remote PC comprises selecting at least one of a plurality of PC resources provided from the remote PC.

9. The method of claim 8, wherein the requesting of the access to the remote PC comprises managing resource information associated with the plurality of PC resources provided from the remote PC.

10. A digital device for connecting to a remote personal computer (PC), comprising:
a provider configured to provide an access scheme for connecting to the remote PC;
a requester configured to request an access to the remote PC in response to executing a remote PC service through a user interface for changing a setting of the digital device;
a setter configured to set a network connection for providing the remote PC service in response to identifying of request information associated with the request being completed in the remote PC;
a receiver configured to encode screen information being displayed on the remote PC as a moving picture, to receive an encoded moving picture from the remote PC, the encoded moving picture being generated by the remote PC by encoding a screen information displayed on the remote PC as a moving picture; and
a player configured to decode the encoded moving picture received from the remote PC and to play the screen information of the remote PC on a display of the digital device.

11. The digital device of claim 10, wherein the provider is configured to provide the access scheme for connecting to the remote PC, the access scheme including a menu-screen based PC service execution scheme for providing the user interface of changing the setting of the digital device or an application-based PC service execution scheme for executing the remote PC service.

12. The digital device of claim 10, further comprising:
a storage configured to store remote PC information that includes an Internet protocol (IP) address or domain information of the remote PC used to connect to the remote PC,
wherein the requester is configured to input the IP address or the domain information of the remote PC to which the digital device desires to connect, based on the stored remote PC information.

13. The digital device of claim 10, wherein the requester is configured to perform a log-in process based on an identifier (ID) and a password in response to executing the remote PC service, and to request the access to the remote PC based on identification information of a user that performs the log-in process.

14. The digital device of claim 10, further comprising:
a transmitter configured to identify information of an input/output (I/O) device in response to detecting a connection of the I/O device, and to transmit an input value of the connected I/O device to the remote PC in response to receiving an input of an instruction for the connected I/O device from a user.

15. The digital device of claim 14, wherein the transmitter is configured to encode screen information associated with a function of the remote PC executed on the remote PC as a moving picture in response to executing the function of the remote PC on the remote PC based on the input value of the connected I/O device, and to stream the encoded moving picture.

16. The digital device of claim 10, wherein the requester is configured to execute the PC remote service by constructing an operating system (OS) environment.

17. The digital device of claim 10, wherein the requester is configured to select at least one of a plurality of PC resources provided from the remote PC, and to manage resource information associated with the plurality of PC resources provided from the remote PC.

18. A method of connecting to a remote personal computer (PC) using an application executed on a digital device, the method comprising:
storing remote PC information that includes an Internet protocol (IP) address or domain information of the remote PC;
redirecting the remote PC information to the digital device in response to executing a remote PC service for connecting to the remote PC;
transmitting an access request from the digital device to the remote PC based on the remote PC information;
receiving a connection accept signal from the remote PC, the connection accept signal transmitted from the remote PC in response to the access request;
requesting the remote PC for screen information displayed on the remote PC;
receiving an encoded moving picture that is generated in response to encoding the screen information being displayed on the remote PC, and requesting the digital device for decoding the encoded moving picture; and
is playing the screen information being displayed on the remote PC in response to decoding the encoded moving picture at the digital device, and receiving a result about the screen information of the remote PC being played.

19. The method of claim 18, further comprising:
receiving an input value of an input/output (I/O) device in response to receiving an input of an instruction for the I/O device connected to the digital device;
redirecting the input value of the I/O device to the remote PC;
decoding, by the digital device, the moving picture that is generated in response to encoding the screen information executed on the remote PC based on the input value, and receiving the result about the screen information of the remote PC being played at the digital device; and
terminating the connection to the remote PC by receiving a use end request of the remote PC service from a user and by transmitting the use end request to the remote PC.

20. A method of operating a remote personal computer (PC) service in a remote PC, the method comprising:
receiving an access request from a digital device;
identifying request information associated with the access request of the digital device and setting a network connection with the digital device;
encoding screen information being displayed on the remote PC service as an encoded moving picture; and
streaming the encoded moving picture to the digital device,
wherein the streaming of the encoded moving picture comprises decoding the encoded moving picture, by the digital device, in response to receiving the encoded moving picture from the remote PC, and playing the decoded moving picture on a display of the digital device.
